(19) United States
(12) Patent Application Publication
(10) Pub. No.: US 2018/0148114 A1
(43) Pub. Date: May 31, 2018

(54) Chassis with Linear and Swiveling Movements

(71) Applicant: Luzerner Werte Holding AG, Luzern (CH)

(72) Inventor: Anton Niederberger, Oberdorf (CH)

(21) Appl. No.: 15/579,604

(22) PCT Filed: Jun. 5, 2016
(86) PCT No.: PCT/EP2016/062735

§ 371 Date: Dec. 5, 2017

(30) Foreign Application Priority Data
Jun. 5, 2015 (CH) 811/15

(51) Int. Cl. B62D 57/024; B62D 57/032

(52) U.S. Cl. CPC B62D 57/024; B62D 57/032

(57) ABSTRACT

The aim of the invention is to achieve a chassis for a robot, which has a low mass, is less susceptible to faults, allows for a continuous drive and an excellent steering capability, and which can overcome small obstacles and negative and positive bumps as well as develop an acceptable travel speed. The invention relates to a chassis (1) for a robot, a manipulator, a driving surface cleaning appliance and/or monitoring devices for navigating on surfaces which are suitable for adhesive modules (4) that can be subjected to a vacuum or electromagnetic force, said adhesive modules having adhesive feet (5) which are constantly facing the driving surface and can be lifted and lowered relative to the driving surface, wherein the adhesive modules (4) are arranged on an at least two-part base structure (1) and wherein a linear movement and a pivoting movement relative to the driving surface are possible. According to the invention, the base structure (1) is composed of at least two base plates (2, 3), wherein the base plates (2, 3) are designed so as to be motor-driven and rotatable relative to each other, and the adhesive modules (4) are arranged on the base plates (2, 3), the individual adhesive modules (4) each having dedicated controllable drives (8) and/or lifting drives (16).

### CROSS REFERENCE TO RELATED APPLICATIONS

This application is the U.S. national stage of International Application No. PCT/EP2016/062735, filed on 2016 Jun. 5. The international application claims the priority of CH 811/15 filed on 2015 Jun. 5; all applications are incorporated by reference herein in their entirety.

### BACKGROUND

### Technical Discipline

The invention concerns the running gear for a robot used to travel as part of vacuum or magnetic attachment modules on suitable surfaces, such as glass facades, metal facades, glass roofs or metal walls for the purpose of inspection, cleaning or servicing.

### State of the Art

From the category-defining DE 103 20 570 B4 a self-climbing running gear for facades, especially glass facades, is known, which exhibits a drive from endless arrays of controllable suction elements. The suction elements run inside the travel surface of the running gear each on two track guides, closed within themselves and mechanically interconnected, where the suction sides of the suction cups always point toward the travel surface. To this end, the suction cups are connected with each other at a fixed distance by a driving mechanism, such as a chain or toothed belt, which is motor-driven. The pulling devices ensure the synchronous circulation of the suction elements per track guide. A pneumatic suction cup control is designed for the uniform lift of the suction cups. Because of the circulation of the suction cups the running gear is preferably of low height, which places its center of gravity close to the travel surface, which helps, for example, avoiding tipping off a vertical wall.

Furthermore, it can be steered very well and allows overcoming minor obstacles, such as glass profile rods or fastening lugs.

A disadvantage of the running gear is that surfaces with more pronounced curvature can be traveled only conditionally since due to the uniformly defined suction cup lift and fixed suction cup spacing the suction cups may either be suspended in the air or pry off the running gear. Sensors monitor conditions presenting dropping hazards and stop the running gear, if necessary. Because of the time-consuming travel at the return points, the travel speed is rather low and the inherent weight, because of its consistent pneumatic control, is relatively high.

Furthermore, EP 0 324 297 A1 is known, which describes a running gear with vacuum suction elements where two linear running gears, arranged vertically to the travel surface above each other, connected with each other relatively swiveling and the linear movement takes place by movement of the running gears relative to each other The heavy and, in addition, inflexible construction, which does not allow for flexible continuous operation, because only complete assemblies can be moved in each case, is a disadvantage.

Furthermore, U.S. Pat. No. 5,890,553 A describes a running gear with vacuum suction elements where a linear running gear and a rotational running gear are arranged relatively rotatable and movable toward each other. A disadvantage, at this, is the rigid construction of the running gear, since all vacuum suction elements are arranged immovably in the direction of movement each on a frame construction and movement is performed only by alternating repositioning of the respective running gear.

Finally, UK 2 299 063 describes running gear consisting of a twistable and in its layout square frame construction with suction elements arranged along its longitudinal outside edges, which can be moved vertically and parallel to the travel surface. Its disadvantage is the inflexible application, especially for a flexible and continuous movement.

### SUMMARY

The invention is based on the task of creating a running gear for a robot with low weight, not much prone to malfunctions, facilitating continuous drive and excellent steerability, able to overcome minor obstacles, both negative and positive bumps, and can develop acceptable travel speed.

Running gear (1) for a robot, manipulator or travel surface cleaning device and/or monitoring devices for traveling on surfaces suitable to be traveled on by use of a vacuum or electromagnet force with admittable suction modules (4) with suction bases (5) always pointing to the travel surface and, in regard to the travel surfaces, suction bases (5) that can be lifted off and lowered, where the suction modules (4) are arranged on an at least two-part basic structure (1) and that a linear movement and a swivel movement relative to the travel surface is possible, where the basic structure (1) consists of at least two base plates (2, 3), where the base plates (2, 3) are designed motor-driven relative to each other, twistable or swiveling, and the suction modules (4) are arranged on the base plates (2, 3), where the individual suction modules (4) each have its own controllable travel drives (8) and/or lifting drives (16).

### DETAILED DESCRIPTION

The invention is based on the task of creating a running gear for a robot with low weight, not much prone to malfunctions, facilitating continuous drive and excellent steerability, able to overcome minor obstacles, both negative and positive bumps, and can develop acceptable travel speed.

The invention achieves in the specified application scenario that a running gear is created for a robot, manipulator or travel surface cleaning device and/or monitoring devices for traveling on surfaces suitable to be traveled on by use of a vacuum or electromagnetic force with admittable suction modules with suction bases always pointing to the travel surface and, in regard to the travel surfaces, suction bases that can be lifted off and lowered, where the suction modules are arranged on an at least two-part basic structure and that a linear movement and a swivel movement relative to the travel surface are possible, where the basic structure consists of at least two base plates, where the base plates are designed motor-driven relative to each other, twistable or swiveling, and the suction modules are arranged on the base plates, where the individual suction modules each have its own controllable travel drives and/or lifting drives.

In addition, a procedure for operating the running gear is created for a linear movement and a swivel movement relative to the travel surface, where for one linear movement as travel drive of the running gear suction bases of liftable and drivable suction modules of a first segment of the base structure each adhere to the travel surface and, each after a completed linear movement, are lifted off and lowered again and that a linear movement of the liftable and drivable suction modules takes place relative to the basic structure and to the running gear, where lifting, lowering and suction of the liftable and drivable suction modules takes place grouped into two, three or more groups, with time and space offset, and that for a swivel movement for the purpose of changing direction suction, bases of liftable and/or drivable suction modules of another segment of the basic structure are lowered on the travel surface and adhere there and the swivel movement of the segment of the basic structure takes place relatively to each other and after this the liftable and/or drivable suction modules of the other segment of the basic structure are lifted off again, while during the swivel movement of the suction bases of the liftable and drivable suction modules of the first segment of the basic structure do not adhere to the travel surface and after the swivel movement the suction bases of the liftable and drivable suction modules of the first segment of the basic structure adhere again to the travel surface.

In that all suction modules, both concerning their movement along their track guides and their lift, can be selected individually and steplessly automatically, many advantages are generated for the running gear and a robot realized with the running gear in operation. The running gear is of particularly low weight, little prone to malfunctions, possesses a superbly fluent and continuous drive capability and steerability, is relatively fast and able to climb over smaller obstacles and more pronounced bumps or steps.

Advantageous designs of the invention are presented for the running gear in claims 2 to 9 and for the procedure in claims 11 to 17.

Advantageously, the base plates are designed as inner base plate and outer base plate, where the suction modules on the inner base plate or the outer base plate each have their own controllable lifting and travel drives and the suction modules of the respective outer base plate or inner base plate each have their own controllable lifting drives. As a result, both, straight movement and also the swivel movement for a directional change can take place reliably and without malfunction, and the running gear achieves a secure grip for all movements and movement conditions on the travel surface, and the motion sequences and directional changes can take place without mutual interference and hindrance.

In that the travel drive of the suction modules advantageously represents a linear drive, the respective travel movements can be executed in a controlled, reliable, stable and focused manner. Straight running can be stabilized and also implemented by design with little effort, which also reduces the weight of the running gear further.

Furthermore, the respective liftable and drivable suction modules feature a combined lifting and travel drive that can be driven by the module's own electric motor, which simplifies the construction as a result of component reduction and also reduces the weight further.

With an advantageous further design, switching from lifting to travel drive is designed automatically controllable for each individual liftable and drivable suction module thereby improving a continuous or fluent motion sequence of the drive. The typical jerky movement of such running gear is reduced, which also improves adhesion and positional security on the travel surface, since the breakaway or tear-away moment of the suction bases from the surface, due to the jerkiness, is reduced or avoided.

Advantageously for the travel operation, the respective liftable and drivable suction modules are arranged on the respective base plate on track guides, offset in parallel to each other and to the side in a regular and/or irregular manner and/or repetitive in longitudinal direction successively, which allows for more favorable suction properties over the surface of the respective base plate during the linear movements. Because of the offset arrangement it is possible that at any time of the linear movement at least half of all suction bases of the liftable and drivable suction modules adhere to the travel surface thereby achieving a secure position also under difficult conditions of the travel surface and, in addition, the continuous linear movement is maintained, since offset and consecutively, the suction bases touch the travel surface and adhere to the same as well as suction bases detach and lift off the same.

With a further design, the track guides include guide rails, improving movement and position of the liftable and drivable suction modules on the respective base plate without coking, rocking and twisting.

Advantageously, the running gear is designed with remote control option, which also allows its use on travel surfaces that cannot be reached directly or without problems and can also be operated from a central location.

Advantageously, the process is further expanded in that before, during or after the swivel movement of the base plates (2, 3) for directional changes a linear movement of the running gear 1 takes place via the liftable and/or drivable suction modules (4) of the other segment of the basic structure (1). The procedure is thereby further optimized since the directional change is performed faster and, in addition, the path is optimized.

Advantageously, during the transition from the linear movement to the swivel movement as well as from the swivel movement to the linear movement, at least some of the suction bases of both segments of the basic structure adhere to the travel surface. This avoids the running gear losing its positional security and adhesion to the travel surface during the change of the direction of movement and during switching of the movement type. In addition, improved suction is achieved during this condition, that is, if necessary, deliberately prolonged, e.g. for maintenance work.

Furthermore, with the procedure, the rotational movement of the segments of the basic structure advantageously is performed by an electric motor or pneumatic drive.

This achieves a reliable and precise drive action and, at the same time, positional stabilization of the segments of the basic structure that can be moved toward each other.

Advantageously, the grouped lifting and drivable suction modules are moved back after the respective linear movement as travel operation with lifted off suction bases to a corresponding starting position. This is followed by putting down the suction bases again on the travel surface at the starting position for another travel operation. This achieves a particularly continuous movement of the running gear, since in each case suction modules grouped together in a suitable manner perform the respective motion sequences with the suction bases simultaneously overlapping or offset and thereby, in addition to the continuous movement, also ensuring the respective required adhesion to the travel surface.

In addition, the lifting operation and/or travel operation takes advantageously place in a continuous and fluent manner. As a result, not only the travel operation takes place continuously but also the lifting movement takes place fluently, adapted to the travel movement, thereby achieving a jerk-free motion sequence. The running gear therefore moves more quietly and is less vulnerable to the external impact of forces.

Furthermore, the formation of the groups, that is, the number of the groups and the number and allocation of the liftable and drivable suction modules in and to the groups takes place in a variable and individual manner. This achieves adhesion to and on the travel surfaces according to the demand. One, two or more suction modules each form a group here.

Advantageously, the selection of the liftable and drivable suction modules for the linear movement takes place individually. This achieves acceleration and speed of the running gear on the travel surface according to the demand. In addition, through the targeted selection of the linear drives of the liftable and drivable suction modules, directional changes and directional adjustments as well as directional corrections can be achieved. Since the suction bases, regularly consisting of rubber, are subject to flexing and lateral shifting, which occurs especially on vertical travel surfaces at horizontal or slanted, that is, sideways travel, constant directional correction is required. This is achieved in that, for example, the respective suction modules pointing downward perform a faster linear movement than the respective suction modules pointing upward. In addition, this allows also performing deliberately minor directional changes. At this, those linear drives of the liftable and drivable suction modules, in which a directional changes shall take place, perform a slower linear movement than the respective other liftable and drivable suction modules.

### BRIEF DESCRIPTION OF THE DRAWINGS

The explanation shall be explained in more detail below using several application examples.

The following is therefore depicted by:

FIG. 1 a running gear for a robot especially for cleaning smooth, firm surfaces, in perspective view from the top,

FIG. 2 a running gear in perspective view from the bottom,

FIG. 3 the principle construction of a track guide for suction modules

FIG. 4 a suction module from its inside in perspective view,

FIG. 5 a suction module from its outside in perspective view,

FIG. 6 a running gear in the view from the bottom

FIG. 7 a running gear as cleaning robot with cleaning brush in top view,

FIG. 8 a running gear as cleaning robot with cleaning brush in side view,

FIG. 9 a running gear as cleaning robot with cleaning brush with view on the cleaning brush from the rear,

FIG. 10 a running gear as cleaning robot with cleaning brush in perspective view from the top,

FIG. 11 a schematic presentation of a basic structure, encompassing two base plates with suction bases and drive for geared ring in perspective view from the top and

FIG. 12 a schematic presentation of a basic structure, encompassing two base plates with suction bases and drive for geared ring in perspective view from the bottom

### DETAILED DESCRIPTION OF THE PREFERRED EMBODIMENTS

### Design of the Invention

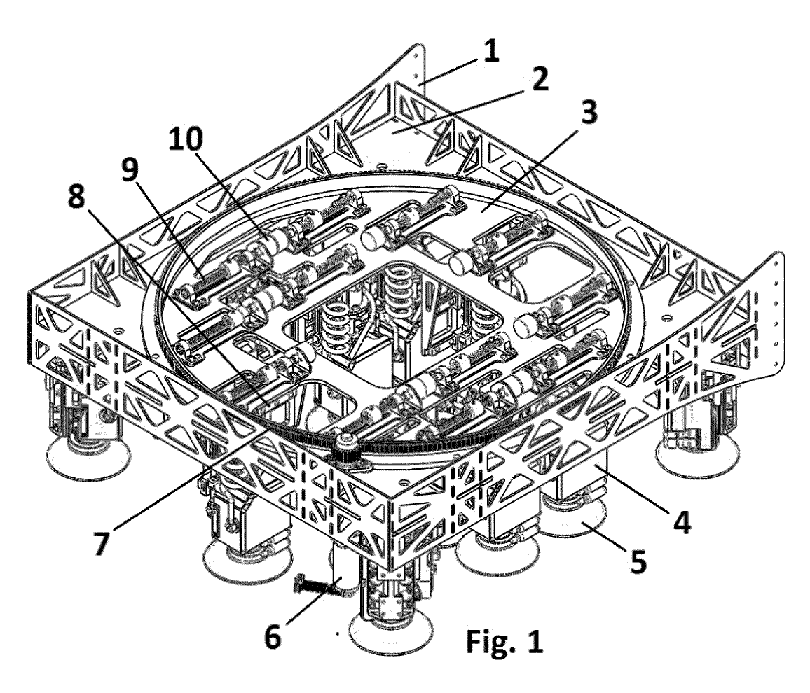

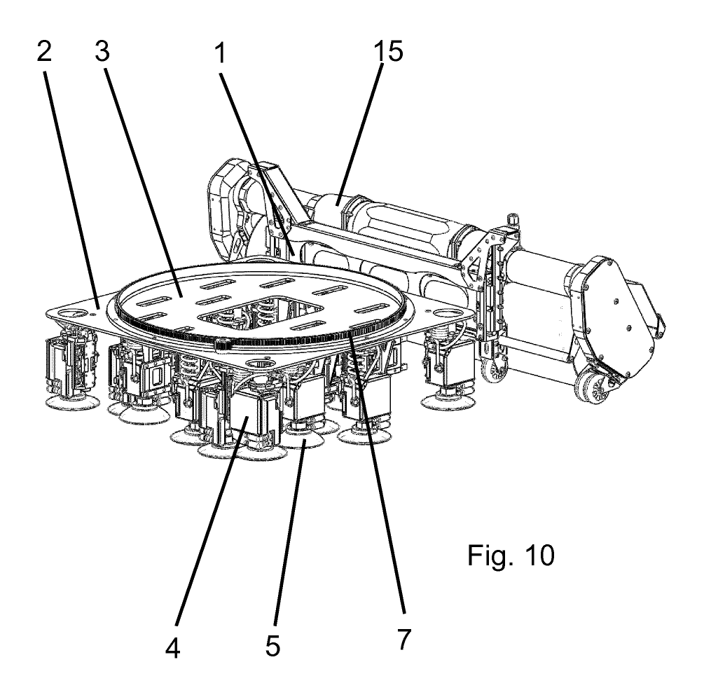

A robot, shown according to FIG. 1 as well as FIG. 10, is suitable, for example, for cleaning glass facades or other solid, smooth, curved surfaces of buildings. For this purpose, its running gear 1 may carry a cleaning device, an inspection camera or remote-controllable manipulator for service and repair tasks.

In a concrete application example, two base plates 2, 3 are arranged parallel to a travel surface of the robot in running gear 1, which are able to move via a geared ring 7, powered by an electric motor 6, and can therefore move swiveling toward each other. In this concrete application example, the outer base plate 2 is directly connected with running gear 1. In the corners of the outer base plate 2 in the concrete application example, suction modules 4 with lifting drive 16 are mounted. The suction bases 5 mounted to the suction modules 4 always point to the travel surface.

On the inner base plate 3 of the concrete application example, running tracks 8 for additional suction modules 4 are attached as liftable and drivable suction modules 4. The liftable and drivable suction modules 4 are moved with the help of linear drives 9 in the form of spindles 9, which are powered by an electric motor 10, along the linear running track. The liftable and drivable suction modules 4 can retract and extend separately via an electropneumatic system. Because each suction module 4 can be selected individually, they can move independently of each other along running track 8 and in their own lift.

In a concrete application example not shown, the liftable and drivable suction modules 4 can be powered by the module's own electric motor as combined lifting drive 16 and travel drive 9. This makes the simultaneous and fluent motion sequence of the liftable and drivable suction modules 4 possible, where, realized by the module's own electric motor, a transition occurs at the respective end—due to the building structure—of the running gear 9 from the linear movement directly to the lifting movement and where at the beginning of each travel movement or linear movement from one end the lifting movement transitions to a travel movement or linear movement.

With another design of the linear drive 9—not shown—of the liftable and drivable suction modules 4, they are powered by a circumferential toothed belt or with rope hoist. With the variant of the drive via linear drive 9, for example, the corresponding gear wheel runs in the intermediate space of the toothed belt, thus optimizing the force transfer.

With the linear movement of running gear 1, only the liftable and drivable suction modules 4 of the inner base plate 3 are utilized in the concrete application example.

Because the suction modules 4 can move freely, a step movement can be generated. An offset of this step movement of the individual suction modules 4 makes it possible to generate a uniform linear movement. In the extended condition, the suction bases 5 of the suction modules 4 can adhere to the surfaces by means of a vacuum.

When switching from the linear to the swivel movement, the outer base plate 2 is first rotated with the help of an electric motor-powered 6 geared ring 7 into the desired direction. As soon as the desired position has been reached, the suction bases 5 of the suction modules 4 of the outer base plate 2 extend and fasten themselves to the surface. The suction modules 4 of the inner base plate 3 detach and the entire base plate 3 moves with the help of the electric motor-powered 6 geared ring 7 to the same orientation as the outer base plate 2. Now the suction bases 5 of the suction modules 4 of the inner base plate 3 can fasten themselves to the surface and the suction bases 5 of the suction modules 4 of the outer base plate 2 can detach. The entire system is now ready again for the linear movement.

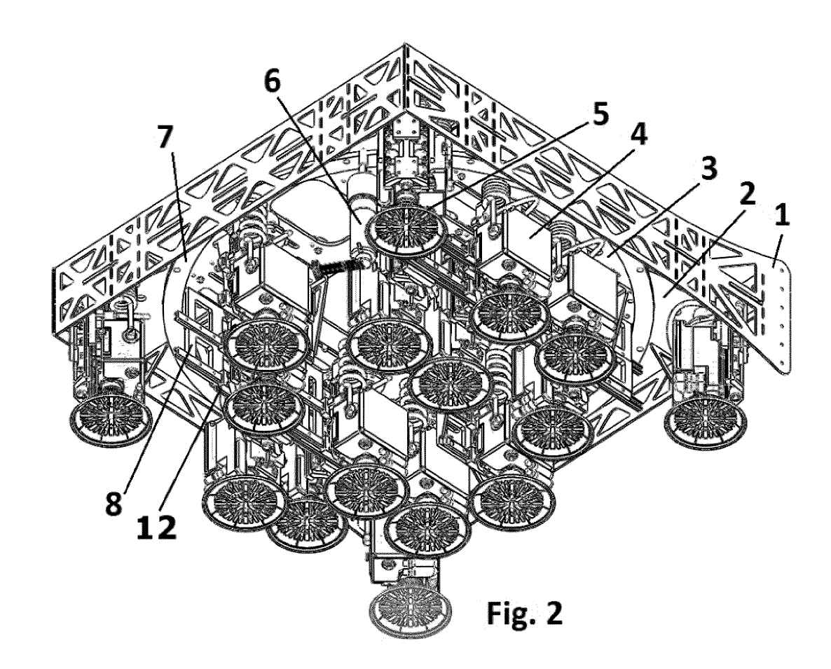

FIG. 2 shows the cleaning robot from its bottom side. The suction modules 4 are equipped with pneumatically operated suction cups as suction bases 5 on their bottom side. Alternatively, small electric magnets can be used for the suction bases 5 if the robot moves on magnetizable surfaces.

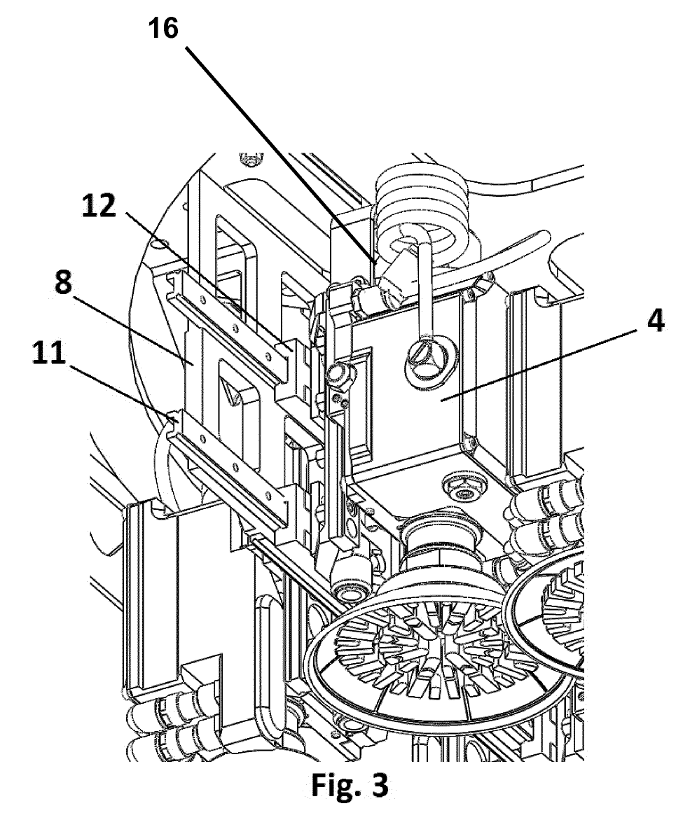

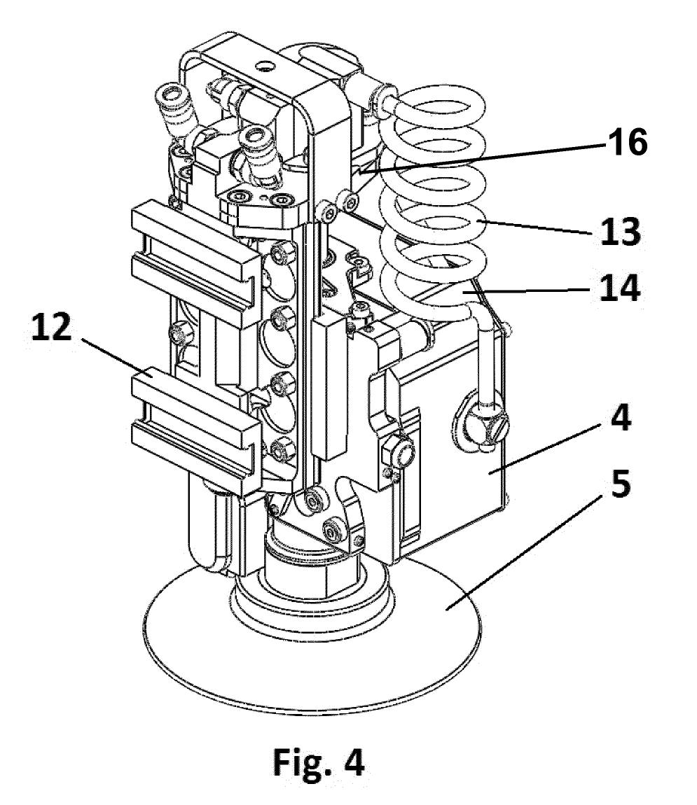

The principal construction of the track guides 8 for suction modules 4 becomes clear from FIG. 3. Each of the track guides 8 consists of a pair of profile rails 11, forming a guide through their vertical spacing, which carries the suction modules 4. FIG. 4 shows an individual suction module 4 from its inside in perspective view. The guides 12 engage with the profile rails 11 of the inner base plate 3. Through the spindles 9 powered by electric motors 10 the suction modules 4 move along the profile rails 11. This implements a stepless travel operation.

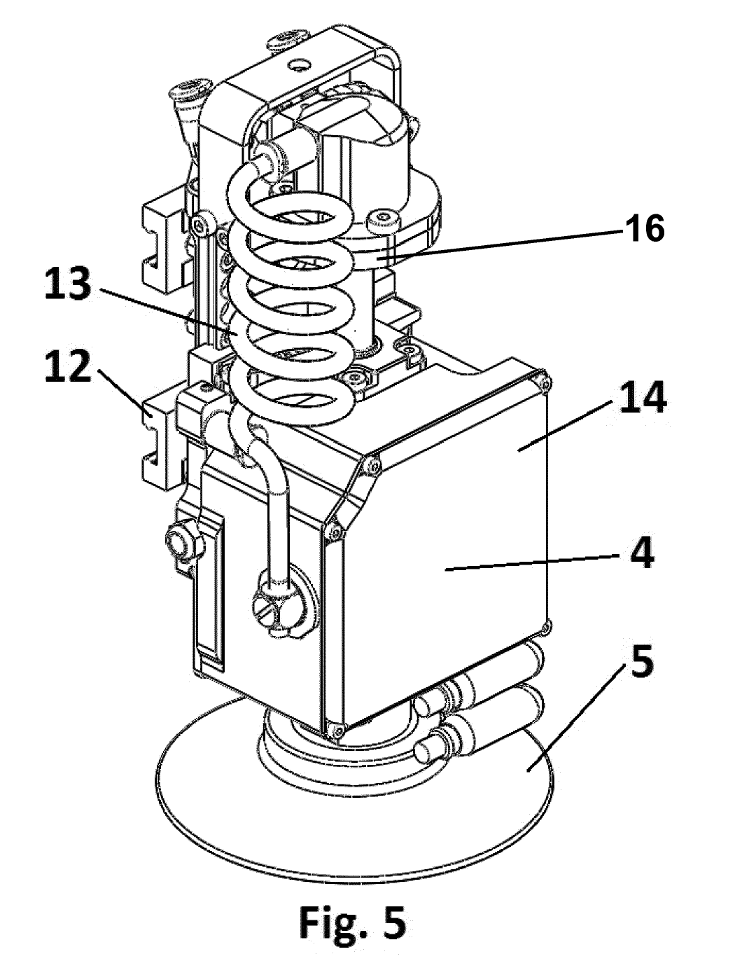

FIG. 5 shows the suction module 4 from its outside in perspective view. The internal pneumatic system 13 serves the stepless putting down and lifting off of the suction base 5 from the travel surface. Furthermore, an electronic unit 14 is provided for each suction module 4, which allows for the individual selection of each suction module 4, both, in regard to driving of the suction modules 4 along the running tracks 8 and also lifting and lowering of the suction bases 5.

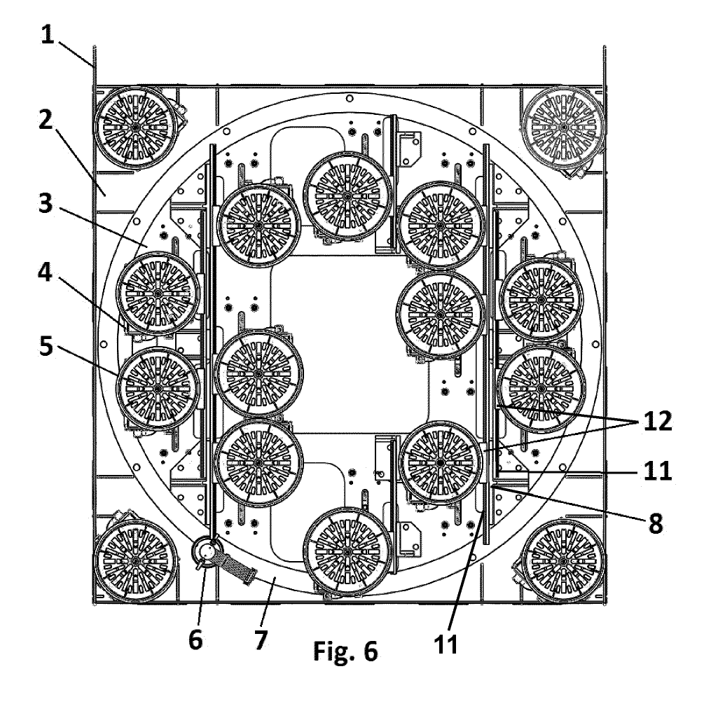

FIG. 6 shows a top view of the cleaning robot on its bottom side. From this view, the running tracks 8 with the profile rails 11, of which only the lower profile rail can be seen, can be recognized especially well.

In the example, twelve suction modules 4 altogether run on combined running track guides 8. Together with the four suction modules 4, fixed on the outer base plate 2, 16 suction bases 5 are provided altogether.

FIG. 6 explains the operating modes where suction modules 4 are spaced apart by means of intelligent computer-assisted control at different distances, where also the lifts of the suction bases 5 may differ.

By quickly returning the unattached suction modules 4, at least half or more than half of suction bases 5 are attached at all times.

Regarding crossing elongated obstacles such as retaining bars, cover strips or the like, diagonally, it is practical to arrange the suction modules 4 in an offset manner according to the slanted angle toward the obstacles between those suction modules that are running on the parallel straight sections. This way such obstacles can be overcome without problem without the robot rising. The obstacle itself is detected by sensors installed on the robot, such as distance sensors or IR sensors.

Running gear 1 can be employed for many different types of work and structural features. However, a preferred area of application is a modification as cleaning robot for slanted and vertical glass and metal walls as well as slanted, curved or inaccessible roofs where the suction bases 5 may consist of pneumatically selected suction cups or electrically selected electric magnets. For this purpose, running gear 1 is designed with remote control and can therefore be operated also from a distance.

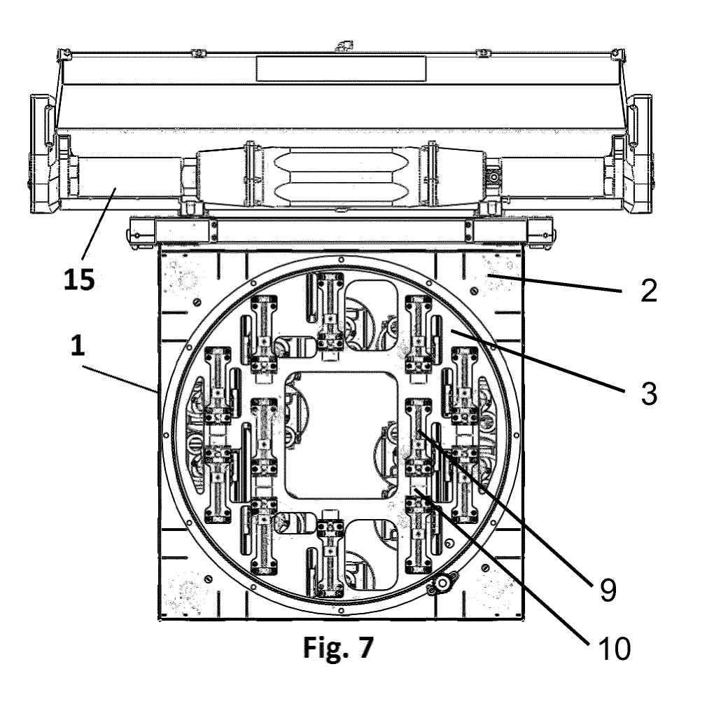

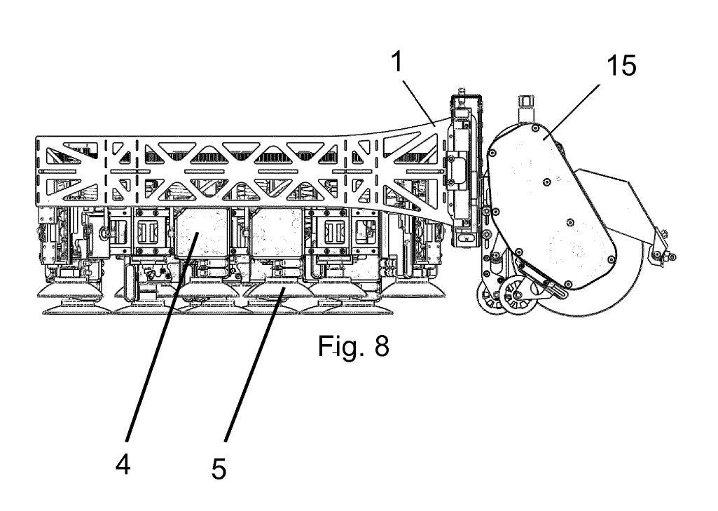

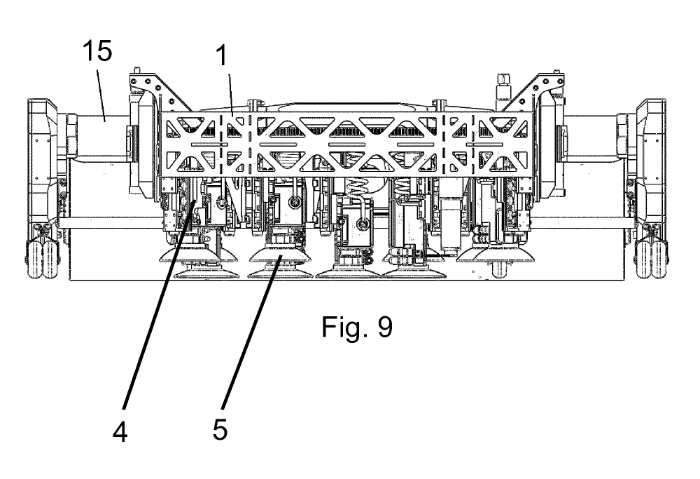

A cleaning robot with brush 15 is shown once more in FIGS. 7 to 9 in top view, side view and front view on the running gear 1.

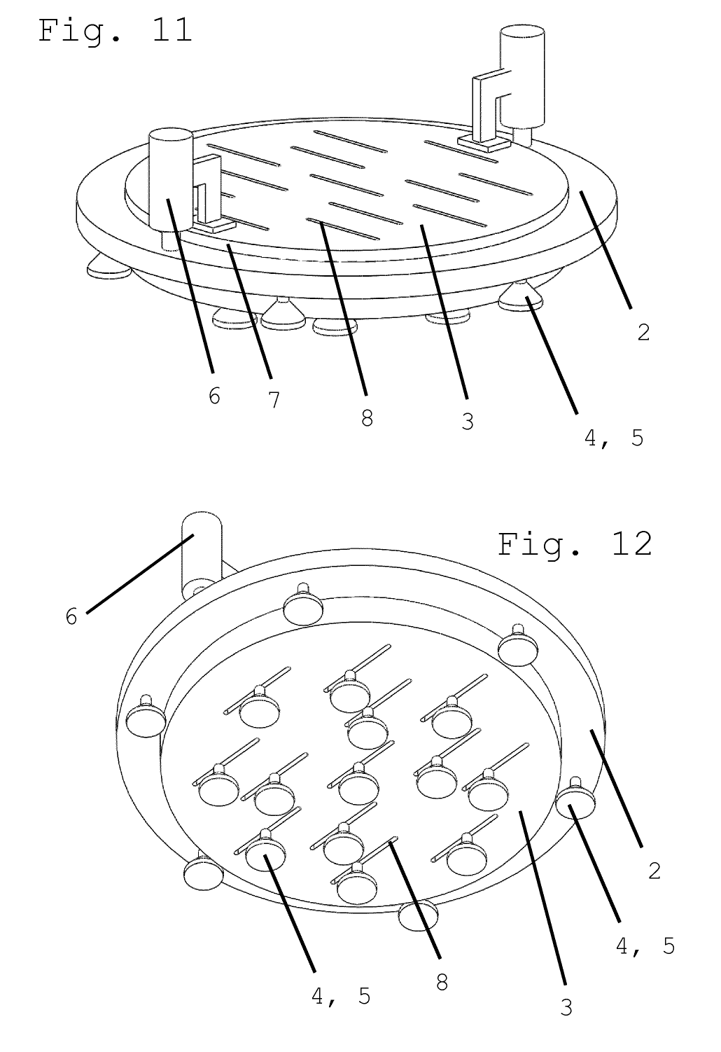

FIGS. 11 and 12 show a schematic arrangement of inner base plate 3 and outer base plate 2, where both base plates 2, 3 are round and the geared ring 7 is operated by two electric motors 7. It can be seen that the suction bases 5 of suction modules 4 on the inner base plate 3 in the given parallel, and at the same time, laterally irregularly arranged offset longitudinal openings, are arranged as running track guides 8 in a movable manner and as linear drive 9.

As described, in the application examples shown, the suction modules 4 are arranged each with one lifting drive 16 and one travel drive 9 at the inner base plate 3 and suction module 4 with only one lifting drive 16 on the outer base plate 2.

Another alternative design, not shown, provides that the liftable and drivable suction modules 4 are arranged on the outer base plate 2 and only the liftable suction modules 4 are arranged on the inner base plate 3. However, all other features of the respective suction modules 4, including the drives, continue to apply since this only concerns a different location of arrangement of the suction modules 4, and the respective function lies with the suction modules 4.

Based on this arrangement of the suction modules 4 with suction bases 5, an operating mode corresponding to the process according to the invention, where for a linear movement as travel operation of running gear 1 the suction bases 5 of liftable and drivable suction modules 4 of a first segment of the basic structure 1, in the concrete application example the inner base plate 3, initially all suction bases 5 adhere to the travel surface and after completed linear movement in time and space-related in the direction of travel and perpendicular to it, successively in groups are lifted off and lowered again, accordingly, where the liftable and drivable suction modules 4 of the inner base plate 3 during the time of non-adherence, that is, while raised, they are moved against the direction of movement of the running gear 1 to a starting position in order to immediately participate again in the travel operation through lowering.

The liftable and drivable suction modules 4 of the inner base plate 3 perform during the travel operation a linear movement relative to the basic structure 1 and running gear 1, where for the follow-up movement of the suction bases 5 for a continuous movement or jerking and halting, the lifting off, lowering and adhesion of the liftable and drivable suction modules 4 takes place in a grouped manner in two, three or more groups with a time and space offset. The groups of liftable and drivable suction modules 4 formed here may contain one, two or more suction modules 4. This number depends on the local conditions and the course of movement.

For a swivel movement for directional change, the suction bases 5 of liftable and/or drivable suction modules 4, in the concrete application example as liftable suction modules 4, are used as liftable suction modules 4, a second segment of the basic structure 1, in the concrete application example as outer base plate 2, are lowered onto the travel surface where they adhere. This is followed by the swivel movement of segments of the basic structure 1 relative toward each other through the selection of electric motor 6 to drive the geared ring 7. After the swivel movement has been completed, the liftable and/or drivable suction modules 4 of the second segment of the basic structure 1 are lifted again. During the swivel movement the suction bases 5 of the liftable and drivable suction modules 4 of the first segment of the basic structure 1 do not adhere to the travel surface. After the swivel movement, the suction bases 5 of the liftable and drivable suction modules 4 of the first segment of the basic structure 1 assume their hold again on the travel surface.

During the transition from the linear movement to the swivel movement and back from the swivel movement to the linear movement, at least part of the suction bases 5 of suction module 4 of both segments or base plates 2, 3 of basic structure 1 adhere again to the travel surface for a short time.

Especially the grouped liftable and drivable suction modules 4 cause at least half of all suction bases 5 to adhere to the travel surface in spite of the fluent motion sequence. After the respective linear movement as travel operation, the liftable and drivable suction modules 4 with lifted off suction bases 5 return to a corresponding starting position through an opposite linear movement. Once reaching the starting position, suction bases 5 are put down again on the travel surface for another travel operation. This creates a continuous and fluent travel operation, which also includes the lifting operation.

The groups formed for this continuous travel operation are dynamic and formed as needed. At this, the number of the groups and the number and allocation of the liftable and drivable suction modules 4 in and to the groups differ. In addition, according to the demand and adjustably, the selection of the liftable and drivable suction modules 4 for the linear movement varies regarding the speed of the linear movement for a balanced and compensated travel operation.

Based on what has been described, another application example is provided. It is therefore provided in an application example, not shown, that both, on the inner base plate 3 and on the outer base plate 2, suction modules 4 are each arranged in a lifting drive 16 and a travel drive 9. The resulting advantages consist of the fact that for a directional change, on the one hand, the base plates 2, 3 are rotated toward each other in the manner described and, on the other hand, in a suitable position of the base plates 2, 3 toward each other, the linear drives 9 are switched in a manner that running gear 1 is moved on the travel surface in a different or diagonally offset area. Furthermore, the arrangement described allows that already during the travel movement, for example, using the travel drive 9, the liftable and drivable suction modules 4 of the outer base plate 2, the inner base plate 3, are already rotated in the desired direction and position by means of the pneumatic motor 6 and the geared ring 6, so that at the given time and location they can immediately travel running gear 1 in the desired direction. Switching between base plates 2, 3 as well as the respective position adjustment can be repeated here in a constantly alternating fashion, if a respective directional changes makes this necessary.

If is also necessary for the position security and stability that at the time of switching the suction modules 4 between base plates 2, 3 at least part of the suction modules 4 of both base plates 2, 3 briefly adhere to the travel surface.

Group formation between the suction modules 4 takes place also in this case making a continuous mode of travel possible. In addition, the other advantages described are applied here.

### LIST OF REFERENCE NUMERALS

1—running gear of a robot, basic structure
2—outer base plate
3—inner base plate
4—suction modules
5—suction base
6—electric motor for geared ring, drive
7—geared ring
8—running tracks for suction modules, running track guides
9—spindle, linear drive, travel drive
10—electric motor for spindle
11—guide rail, profile rails
12—guides on the base
13—pneumatics in base
14—electronics for base
15—cleaning brush
16—lifting drive

1-17. (canceled)

18. Running gear (1) for a robot, manipulator, a travel surface cleaning device and/or monitoring devices for traveling on surfaces suitable to be traveled on by use of a vacuum or electromagnet force with admittable suction modules (4) with suction bases (5) always pointing to the travel surface and, in regard to the travel surfaces, suction bases (5) that can be lifted off and lowered, where the suction modules (4) are arranged on an at least two-part basic structure (1) and that a linear movement and a swivel movement relative to the travel surface is possible,
characterized in that
the basic structure (1) consists of at least two base plates (2, 3), where the base plates (2, 3) are designed relative to each other as motor-driven, rotatable and the suction modules (4) are arranged on the base plates (2, 3), where the individual suction modules (4) each have their own controllable travel drives (9) and/or lifting drives (16).

19. Running gear according to claim 18,
characterized in that
the base plates (2, 3) are designed as inner base plate (3) and outer base plate (2),
where the suction modules (4) on the inner base plate (3) or the outer base plate (2) each have their own controllable lifting drives (16) and travel drives (9) and the suction modules (4) of the respective outer base plate (2) or inner base plate (3) each have their own controllable lifting drives (16).

20. Running gear, according to claim 18,
characterized in that
the travel drive (9) of the suction modules (4) is a linear drive (9).

21. Running gear, according to claim 18,
characterized in that
the respective liftable and drivable suction modules (4) feature a combined lifting drive (16) and travel drive (9) that can be driven by the module's own electric motor (9).

22. Running gear, according to claim 18,
characterized in that
switching from lifting operation to travel operation is designed automatically controllable for each individual liftable and drivable suction module (4).

23. Running gear, according to claim 18,
characterized in that
the lifting operation and/or driving operation is designed stepless in each case.

24. Running gear, according to claim 18,
characterized in that
for the travel operation, the respective liftable and drivable suction modules (4) are arranged on the respective base plate (2, 3) on running track guides (8) offset in parallel to each other and to the side in a regular and/or irregular manner and/or repetitive in longitudinal direction successively.

25. Running gear according to claim 24,
characterized in that
the running track guides (8) include guide rails (11).

26. Running gear, according to claim 18,
characterized in that
the running gear (1) is designed for remote control.

27. Procedure for operating the running gear (1) for a robot, manipulator, a travel surface cleaning device and/or monitoring devices for traveling on surfaces suitable to be traveled on by use of a vacuum or electromagnet force with admittable suction modules (4) with suction bases (5) always pointing to the travel surface and, in regard to the travel surfaces, suction bases (5) that can be lifted off and lowered, where the suction modules (4) are arranged on an at least two-part basic structure (1) and that a linear movement and a swivel movement relative to the travel surface is possible,
characterized in that
for a linear movement as travel drive of the running gear (1) suction bases (5) of liftable and drivable suction modules (4) of a first segment of the basic structure (1) each adhere to the travel surface and, each after a completed linear movement are lifted off and lowered again and that a linear movement of the liftable and drivable suction modules (4) takes place relative to the basic structure (1) and to the running gear (1), where lifting, lowering and adhesion of the liftable and drivable suction modules (4) takes place grouped into two, three or more groups, with time and space offset and, the number of the groups and the number and allocation of the liftable and drivable suction modules (4) in and to the groups takes place in a variable and individual manner and
that for a swivel movement for the purpose of changing direction suction bases (5) of liftable and/or drivable suction modules (4) of another segment of the basic structure are lowered on the travel surface and adhere there and the swivel movement of the segments of the basic structure (1) takes place relative to each other and after this the liftable and/or drivable suction modules (4) of the other segment of the basic structure (1) are lifted off again, as to while during the swivel movement of the suction bases (5) of the liftable and drivable suction modules (4) of the first part of the basic structure (1) do not adhere to the travel surface and after the swivel movement the suction bases (5) of the liftable and drivable suction modules (4) of the first segment of the basic structure (1) adhere again to the travel surface.

28. Procedure according to claim 27,
characterized in that
before, during or after the swivel movement of the base plates (2, 3) for directional change a linear movement of the running gear 1 takes place via the liftable and/or drivable suction modules (4) of the other segment of the basic structure (1).

29. Procedure according to claim 27,
characterized in that
during the transition from the linear movement to the swivel movement as well as from the swivel movement to the linear movement, at least some of the suction bases (5) of the suction modules (4) of both sections of the basic structure adhere to the travel surface.

30. Procedure according to claim 27,
characterized in that
the rotational movement of the segments of the basic structure (1) is performed by an electric motor or pneumatic drive (6).

31. Procedure according to claim 27,
characterized in that
the grouped liftable and drivable suction modules (4) are moved back after the respective linear movement as travel operation with lifted off suction bases (5) to a corresponding starting position and that at the starting position suction bases (5) are put down again on the travel surface for another travel operation.

32. Procedure according to claim 27,
characterized in that
the lifting operation and/or travel operation takes advantageously place in a continuous and fluent manner.

33. Procedure according to claim 27,
characterized in that
the selection of the liftable and drivable suction modules (4) for the linear movement takes place individually.
